(19) United States
(12) Patent Application Publication
(10) Pub. No.: US 2026/0295562 A1
(43) Pub. Date: Oct. 1, 2026

(54) SELF-HEALING SURFACE COATING SYSTEMS FOR PASSIVE POLLUTANT DEGRADATION

(71) Applicant: Joseph Allen Menzel, Baldwinsville, NY (US)

(72) Inventor: Joseph Allen Menzel, Baldwinsville, NY (US)

(21) Appl. No.: 19/333,760

(22) Filed: Sep. 19, 2025

Related U.S. Application Data
(60) Provisional application No. 63/779,557, filed on Mar. 28, 2025.

(51) Int. Cl. B01J 21/06; B01J 21/18; B01J 31/06; B01J 35/39; B01J 35/52

(52) U.S. Cl. CPC B01J 21/063; B01J 21/18; B01J 31/06; B01J 35/39; B01J 35/52

(57) ABSTRACT

A self-healing air purification system and related methods of use and deployment are disclosed. The system includes a substrate, at least one functional layer, and a capsule. The functional layer is disposed over the substrate. The functional layer includes a healing agent, a first photocatalyst, and a hydrophilic material. The healing agent is configured to heal a damage site proximate to the functional layer. The first photocatalyst is configured to degrade an airborne pollutant. The hydrophilic material is configured to facilitate adsorption of the pollutant thereon. The system further includes a capsule dispersed in the functional layer. The capsule includes a shell encapsulating a second photocatalyst. The shell is configured to rupture upon exposure to a physical agent to release the second photocatalyst toward the damage site.

### TECHNICAL FIELD

The present application generally relates to air purification systems, and particularly relates to self-healing surface coating systems for passive pollutant degradation on urban infrastructure surfaces.

### BACKGROUND

Air pollution is a persistent global threat to public health and urban infrastructure. Existing air purification systems typically employ powered devices, replaceable filters, or chemical replenishment, all of which require frequent maintenance and incur high operating costs.

In contrast, modern surface coatings with air purification capabilities offer a passive and cost-effective alternative. For example, photocatalytic coatings, such as those containing titanium dioxide (TiO₂), can adsorb and degrade airborne pollutants. However, these photocatalytic coatings typically exhibit low abrasion resistance and undergo a gradual loss of photocatalytic activity over time. Physical abrasion, ultraviolet radiation, temperature fluctuations, and chemical attack further reduce their performance, necessitating frequent reapplication or replacement and limiting large-scale adoption of these photocatalytic coatings. Additionally, such coatings and the underlying structural materials are prone to scratches and cracks during use. If unrepaired, this damage propagates, exposing substrates to corrosion, discoloration, and mechanical failure. Repairing the substrates is costly, generates waste, and minor defects often go undetected until significant deterioration occurs.

Self-healing materials offer a potential solution to these challenges. They can repair themselves with or without external stimuli such as heat or radiation, making them attractive for industrial and urban applications. Self-healing materials are generally classified as intrinsic or extrinsic. Intrinsic self-healing systems typically rely on dynamic covalent bond formation, often triggered by heat or radiation, to restore damaged areas. This heat-or radiation-induced healing softens damaged surfaces to cause them to physically move into re-contact with each other to reform bonds, compromising mechanical strength of the coatings and the substrates. Moreover, intrinsic self-healing systems suffer gradual loss of photocatalytic material from damage sites, reducing long-term photocatalytic performance. Extrinsic self-healing systems employ pre-embedded healing materials that react to repair cracks. However, these pre-embedded materials often degrade, leak, or deactivate, compromising surface repair and texture. Moreover, similar to intrinsic systems, extrinsic self-healing systems lose photocatalytic material at damage sites, diminishing air purification capability over time.

Accordingly, there remains a need for a durable, scalable, passive surface coating system with a self-healing mechanism capable of autonomously restoring structural integrity while preserving long-term photocatalytic performance for pollutant degradation.

### SUMMARY

Aspects of the present application address the aforementioned drawbacks in the existing solutions by providing a layered self-healing coating, which upon receiving a damage, triggers embedded capsules to release one or more photocatalytic materials and/or healing agents, thereby simultaneously repairing the damage and restoring the coating's pollutant-degrading capability.

One embodiment of the present application includes a self-healing air purification system including a substrate, a first functional layer, a second functional layer, and a capsule. The first functional layer may be disposed over the substrate. The first functional layer may include a first photocatalyst configured to degrade an airborne pollutant and a hydrophilic material to facilitate adsorption of the pollutant thereon. The second functional layer may be disposed in contact with the first functional layer. The second functional layer may include a healing agent configured to heal a damage site at an interface of the first layer and the second layer. The capsule may be dispersed in the second functional layer. The capsule may include a shell encapsulating a second photocatalyst, where the shell may be configured to rupture upon exposure to a physical agent to release the second photocatalyst toward the damage site. Such multi-layer self-healing air purification system may passively degrade pollutants and renew a functionality (e.g., fluid purification, photocatalytic capacity, surface repair, structural integrity maintenance, repair, or improvement, etc.) of intended surfaces, such as the first layer and/or the second layer, upon damage.

Another embodiment of the present application includes a self-healing air purification system including a substrate, at least one functional layer, and a capsule. This functional layer may be disposed over the substrate. The functional layer may include a healing agent configured to heal a damage site proximate to the at least one functional layer, a first photocatalyst configured to degrade an airborne pollutant, and a hydrophilic material configured to facilitate adsorption of the pollutant thereon. The capsule may be dispersed in the functional layer. The capsule may include a shell encapsulating a second photocatalyst, where the shell may be configured to rupture upon exposure to a physical agent to release the second photocatalyst toward the damage site.

Aspects of the present application provide a multi-layer self-healing coating system and a single-layer self-healing coating system for urban infrastructure surfaces, where these coating systems passively degrade pollutants and renew a functionality of the surfaces after damage.

The above summary of exemplary embodiments is not intended to describe each disclosed embodiment or every implementation of the present application. Other aspects and features of the disclosure will be evident from the following detailed description, which is intended to illustrate, not limit, the present application.

### BRIEF DESCRIPTION OF THE DRAWINGS

FIG. 1 is a schematic of an exemplary self-healing surface coating system including an assembly of multiple functional layers, according to an embodiment of the present application.

FIG. 2 is a schematic of an exemplary first layer of the system of FIG. 1, according to an embodiment of the present application.

FIG. 3 is a schematic of an exemplary second layer of the system of FIG. 1, according to an embodiment of the present application.

FIGS. 4-15 are schematics of exemplary self-healing capsules for the second layer of FIG. 3, according to various embodiments of the present application.

FIG. 16 is a schematic of the second layer of FIG. 3 including exemplary acoustic-damping materials, according to an embodiment of the present application.

FIGS. 17-19 are schematics of an exemplary self-healing surface coating system including a single functional layer, according to various embodiments of the present application.

FIGS. 20-21 are schematics of the single functional layer of FIGS. 17-19, according to various embodiments of the present application.

FIG. 22 is a flowchart illustrating exemplary steps of implementing the system of FIG. 1, according to an embodiment of the present application.

FIG. 23 is a schematic of an exemplary process carried out using the system of FIG. 1 to repair a damage site and replenish photocatalytic materials therein, according to an embodiment of the present application.

### DETAILED DESCRIPTION

The following detailed description is provided with reference to the drawings. Exemplary embodiments are presented as illustrative examples so as to enable those skilled in the art to practice the invention(s) in this application. It will be appreciated that further variations of the concepts and embodiments disclosed herein can be contemplated. The examples described in the present application may be used together in different combinations. In the following description, details are set forth to provide an understanding of the present application. It will be readily apparent, however, that the application may be practiced without limitation to all these details in some embodiments. Also, throughout the present application, the terms “a” and “an” denote one or more of a particular element. The term “includes” means includes but not limited to, and the term “including” means including but not limited to. The term “based on” means based at least in part on, the term “based upon” means based at least in part upon, and the term “such as” means such as but not limited to. The terms “approximately” and “about” mean within ±5% of a stated value.

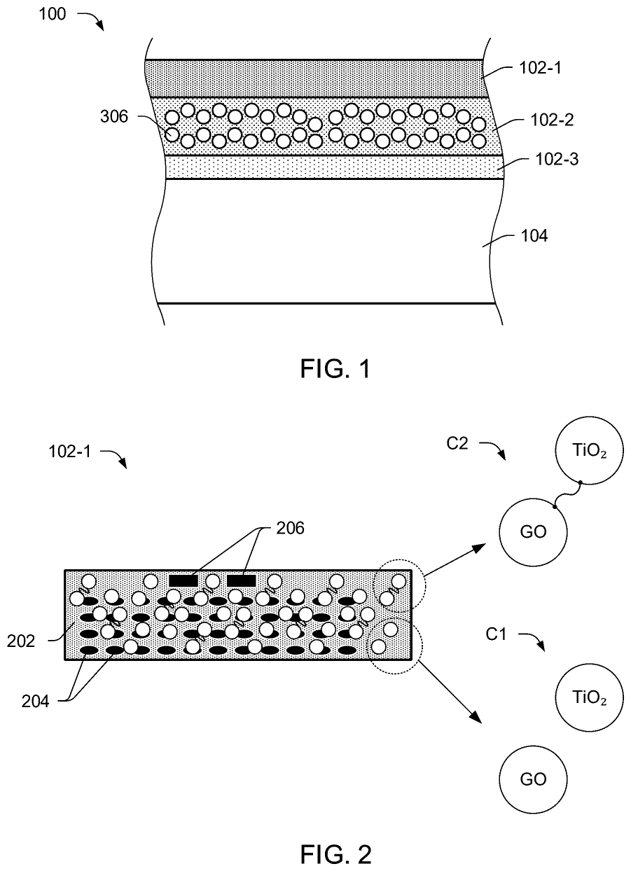

FIG. 1 is a schematic of an exemplary self-healing surface coating system 100 including an assembly of multiple functional layers, according to an embodiment of the present application. Embodiments are disclosed in the context of a modular, multifunctional, non-powered self-healing surface coating system 100 (or simply “self-healing system 100”) that passively degrades airborne pollutants on urban infrastructure surfaces while restoring surface continuity following damage. However, the concepts described herein may be implemented in various systems and articles, as well as used to formulate various coating compositions that can autonomously replenish and repair their photocatalytic capacity as well as structural integrity upon damage (e.g., damage under environmental stress and/or mechanical force). In the present application, references to “damage” may include scratches, abrasions, scuffs, cuts, punctures, chips, dents, cracks, fractures, spalling, delamination, erosion, corrosion, or any combinations thereof. Further, in the present application, references to “coating composition” may include any formulation comprising one or more materials, in predetermined types and/or quantities, combined to serve an intended function or impart an intended property. In some embodiments, the self-healing system 100 may be further configured to attenuate an intended sound (e.g., noise).

The self-healing system 100 and variations thereof may be implemented to or with a variety of articles known in the art or developed later. The articles, when coated with or attached to the self-healing system 100, may passively degrade pollutants in the ambient environment (e.g., air or water streams).

In one embodiment (FIG. 1), the self-healing system 100 has a multi-layer configuration. The system 100 may include an assembly of one or more functional layers 102 implemented on a substrate 104. Each of the layers 102 may include the same or different types of coating compositions. In the present application, references to “substrate” may include materials, surfaces, articles, or any combinations thereof on which a predetermined coating composition can be applied, deposited, or bonded. Examples of substrate types include, but are not limited to, asphalt, concrete, stone, ceramic, metals, alloys, polymers, wood, and glass. The substrate 104 may be porous or non-porous. The substrate 104 may be flexible, semi-rigid, or rigid. In some examples, the substrate 104 may represent or include an article. Examples of types of articles include, but are not limited to, building and infrastructure components (e.g., wall panels, architectural facades, road modules or slabs, sidewalk slabs or tiles, roadside barrier panels, bridges, benches, railings, handrails, streetlight poles, sign posts, etc.), transportation and mobility components (e.g., vehicle body panels, aircraft fuselage and interior panels, ship hull structures, bicycle and automotive frames, truck trailers, cargo containers, etc.), industrial equipment and machinery (e.g., HVAC casings and ducts, storage tanks, conveyor belts, robotic arms and housings, fluid filters, etc.), consumer and commercial products (e.g., furniture frames, countertops, display cases, refrigerator panels, protective glass, etc.), and environmental and energy system modules (e.g., solar panels or covers, turbine blades, water treatment components, sensor housings, etc.).

The one or more functional layers 102 may be continuous or separated by organic or inorganic partitions. In some embodiments, the one or more functional layers 102 (or the corresponding coating compositions) may be applied, deposited, or bonded to the substrate 104 in a set sequence or pattern to achieve intended effects such as passively degrading pollutants, maintaining or improving structural integrity, adhesion to an adjoining surface, repairing a damaged surface, and/or attenuating noise. In the present application, references to “degrade” may include remove, neutralize, decompose, extract, filter, or any combinations thereof. The self-healing system 100 (or one or more coating compositions related thereto) may be applied to the substrate 104, to one or more of the functional layers 102, and/or to the articles using any suitable coating methods known in the art, including casting, spraying, spinning, dipping, atomizing, immersion, or roll-coating. These coating methods may be performed at a temperature less than, greater than, or the same as ambient temperature, depending on the coating method and/or the coating composition. One or more of the functional layers 102 may be applied, deposited, or bonded to surfaces that are horizontal, vertical, or angled relative to a longitudinal axis (or a central axis) of the system 100 and/or the substrate 104.

As illustrated in FIG. 1, in one embodiment, the self-healing system 100 includes a first layer 102-1, a second layer 102-2, and an optional third layer 102-3 (collectively referred to as functional layers 102). In the present application, references to “functional layers 102” include at least the first layer 102-1 and the second layer 102-2, or a single layer including aspects (e.g., function, structure, composition, ingredient, etc.) of both the first layer 102-1 and the second layer 102-2. For the sake of clarity and brevity in description, the functional layers 102 are referred to exclude the third layer 102-3, unless the context explicitly indicates otherwise. It should be understood by those skilled in the art that the functional layers 102 may be implemented with or without the third layer 102-3 in relation to various embodiments, variations, or configurations described in the present application.

The first layer 102-1 may be exposed to an external environment during use or storage. In the present application, references to “external environment” may refer to surrounding physical, chemical, and/or biological conditions in which an article, coating, composition, capsule, and/or system may be situated and/or exposed during use or storage. For example, the external environment may include any external medium or set of conditions that interact with the system 100 from outside its structural boundaries. Examples of external environment includes, but are not limited to, atmospheric conditions (e.g., ambient air, pollutants, humidity/moisture, etc.); physical conditions (e.g., temperature fluctuations, ultraviolet UV light, visible light, mechanical stress, air pressure fluctuations, etc.); chemical agents (e.g., acids, bases, salts, etc.); and biological factors (e.g., microorganisms, spores, organic debris, dust, pollen, etc.), or any combinations thereof. In some examples, the external environment may pertain to a hollow space or interior of an article.

The first layer 102-1 may operate as a purification layer configured to adsorb and degrade a variety of pollutants in the external environment. Examples of pollutants include, but are not limited to, sulfur dioxide (SO₂), nitrogen oxides (NOₓ), volatile organic compounds (VOCs), and fine particulate matter (PM_{2·5}, PM₁₀). In the present application, references to “pollutant” may include any chemical substance, species (molecular, ionic, or radical), compound, pathogen, particulate matter, or any combination thereof that poses a risk to human health, the environment, or infrastructure. The pollutants may be airborne or present in any fluid such as air, water, gases, and multi-phase fluids. The first layer 102-1 may form or include an external surface of the self-healing system 100 (for example, the top or outermost layer in FIG. 1). The first layer 102-1 may be disposed over the substrate 104. For example, as illustrated, the first layer 102-1 forms a top layer (or an upper layer) of the system 100. However, in some implementations, the first layer 102-1 may also be applied as a lateral or side coating on a surface of the system 100 or of the substrate 104.

The self-healing system 100, in one embodiment, further includes the second layer 102-2. In one example, the second layer 102-2 may be located adjacent to the first layer 102-1. The second layer 102-2 may be disposed in contact with the first layer 102-1. The second layer 102-2 may form a bottom layer (or a lower layer) of the self-healing system 100. For instance, the second layer 102-2 may be disposed directly beneath the first layer 102-1; however, in some examples, the second layer 102-2 may be disposed over the first layer 102-1. Relative to the first layer 102-1, the second layer 102-2 may be closer to the substrate 104, for example, in a coated article. In the present application, “coated article” may refer to any article, substrate, surface, or structural material coated with an intended coating composition or attached to the self-healing system 100. The first layer 102-1 may be applied, bonded, or deposited onto the second layer 102-2, or vice versa. In some embodiments, a portion of the first layer 102-1 may be applied directly on the substrate 104, bypassing the second layer 102-2. For example, if the second layer 102-2 may be absent in a portion of the substrate 104, the first layer 102-1 may be applied directly on the portion or on another layer (e.g., the third layer 102-3).

In one embodiment, the second layer 102-2 operates as a self-healing layer configured to passively heal or repair damage sites within itself and at adjoining surfaces or layers (such as an interface with first layer 102-1) of the self-healing system 100. For example, the second layer 102-2 can include one or more self-healing capsules such as a capsule 306, discussed below in greater detail, to heal or repair damage at the interface between the second layer 102-2 and the first layer 102-1. In the present application, references to “capsule” are intended to encompass a single capsule or a plurality of such capsules. For the sake of clarity and brevity in description, a single capsule 306 is referred to hereinafter. However, it should be understood by those skilled in the art that, in practice, one or more capsules 306 may be employed, whether of the same type or of different types, in any of the embodiments, variations, or configurations described in the present application.

In some embodiments, the second layer 102-2 may be positioned behind (or under) the first layer 102-1, which may help prevent or reduce direct exposure of the second layer 102-2 to the external environment. However, in some instances, portions of the second layer 102-2 may get exposed to the external environment (e.g., if a top layer such as the first layer 102-1 does not fully cover the second layer 102-2). The second layer 102-2 may be distinct from the first layer 102-1; however, some examples may include the second layer 102-2 being formed integrally with the first layer 102-1 (e.g., a gradient or hybrid layer where their respective functionalities may overlap).

The second layer 102-2 may be applied, bonded, or deposited directly onto the substrate 104 or applied over an intervening layer. In one embodiment (as in FIG. 1), the second layer 102-2 interfaces between the first layer 102-1 and the third layer 102-3 (or directly the substrate 104). For example, the second layer 102-2 may be applied, deposited, or bonded onto the third layer 102-3, which may be attached to the substrate 104. The third layer 102-3 may be distinct from the substrate 104; however, in some examples, the third layer 102-3 may be physically integral with (or functionally integral to) the substrate 104, or vice versa.

In one embodiment, the third layer 102-3 operates at least in part as a primer layer configured to assist adhesion of the second layer 102-2 to the substrate 104. For example, the third layer 102-3 can bind to the second layer 102-2, holding that self-healing layer securely to the substrate 104. The third layer 102-3 may interface between the second layer 102-2 and the substrate 104. The third layer 102-3 may be optional in embodiments, for example, where the second layer 102-2 (or the first layer 102-1) may include a coating composition that can directly bind or attach to the substrate 104. The third layer 102-3 may include a single layer or a set of multiple sub-layers. For example, a coated article may include an additional adhesive sub-layer (a “secondary” third layer 102-3) between the first layer 102-1 and the second layer 102-2 to help bind them together. In another example, a “tertiary” third layer 102-3 may be applied to the substrate 104, for example, before the remaining of the layers 102, to promote adhesion of the first layer 102-1 directly to the portion of the substrate 104. Each instance of the third layer 102-3 (primary, secondary, tertiary) may use the same or different coating compositions containing suitable adhesive materials known in the art or developed later. Examples of adhesive materials include, but are not limited to, polyurethane-based adhesives (e.g., polyurethane prepolymers), epoxy-based adhesives (e.g., bisphenol-A epoxy resin, bisphenol-F epoxy resin, novolac epoxy, cycloaliphatic epoxy, etc.), silane coupling agents (e.g., γ-glycidoxypropyltrimethoxysilane (GLYMO), 3-aminopropyltriethoxysilane (APTES), 3-mercaptopropyltrimethoxysilane (MPTMS), vinyltrimethoxysilane (VTMS), methacryloxypropyltrimethoxysilane (MPTS), etc.), hybrid adhesives (e.g., epoxy-silane hybrids, polyurethane-silane hybrids, epoxy-acrylate hybrids, etc.), phenol-formaldehyde resins, cyanate ester resins, and polyimide adhesives, or any suitable combinations thereof. The adhesive materials may be chosen to be compatible with the interacting coating compositions of the functional layers 102 (such as the polymer matrices of second layer 102-2 and first layer 102-1) and with a surface of the substrate 104. In some examples, the adhesive materials may promote compatibility and bonding between these interacting surfaces, compositions, and layers such as the functional layers 102. Such an adhesive material may constitute approximately 10% to 20% by weight of the coating composition of the third layer 102-3 (or of the entire self-healing system 100).

Each of the functional layers 102 may have the same or different thicknesses or other dimensions (e.g., length, width, area, curvature, volume, etc.) relative to each other or to the substrate 104. For example, the first layer 102-1 and the second layer 102-2 together may have a combined thickness ranging from approximately 0.3 mm to approximately 2.5 mm. In another example, a combination of the first layer 102-1 and the third layer 102-3 may have a thickness of about 0.3 mm to about 2.5 mm. In yet another example, the second layer 102-2 together with the third layer 102-3 may have a combined thickness of about 0.3 mm to about 2.5 mm. Further examples include at least one of the functional layers 102 having a thickness of about 0.3 mm to about 2.5 mm, or all functional layers 102 together having a total thickness in the same range of about 0.3 mm to about 2.5 mm. In certain embodiments, a primer layer (such as the third layer 102-3) may have a thickness of about 25-75 μm, the self-healing second layer 102-2 may have a thickness of about 300-1000 μm, and the photocatalytic first layer 102-1 may have a thickness of about 20-100 μm, for a total coating thickness on the order of approximately 0.35-1.2 mm.

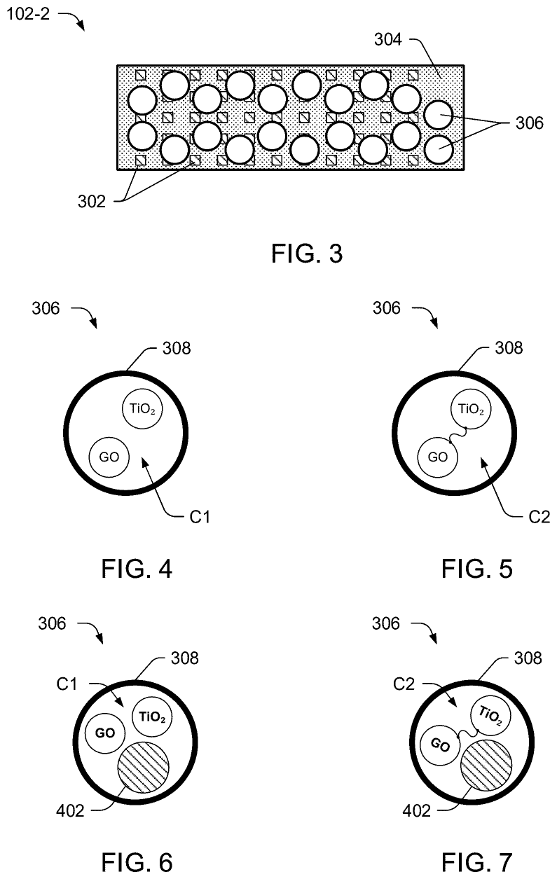

FIG. 2 is a schematic of an exemplary first layer 102-1 of system 100 (from FIG. 1), according to an embodiment of the present application. In one embodiment, the first layer 102-1 includes a photocatalytic coating composition with one or multiple types of photocatalysts. For example, the photocatalytic coating composition includes a photocatalyst 204 dispersed in a polymer binder 202. The photocatalyst 204 may be selected to remain functionally stable, alone or in combination with a suitable type of polymer binder 202, under various ambient conditions. In some examples, the polymer binder 202 may be formulated to be stable under ultraviolet light exposure. The photocatalyst 204 may be made of or include any suitable photocatalytic materials known in the art or later developed. Examples of photocatalytic materials include, but are not limited to: metal oxides (e.g., titanium dioxide (TiO₂), zinc oxide (ZnO), tungsten trioxide (WO₃), tin dioxide (SnO₂), ferric oxide (Fe₂O₃), bismuth trioxide (Bi₂O₃), etc.); complex oxides (e.g., bismuth vanadate (BiVO₄), strontium titanate (SrTiO₃), potassium tantalate (KTaO₃), sodium niobate (NaNbO₃), calcium ferrite (CaFe₂O₄), etc.); sulfide and selenide photocatalysts (e.g., cadmium sulfide (CdS), zinc sulfide (ZnS), molybdenum disulfide (MoS₂), copper indium disulfide (CuInS₂), cadmium selenide (CdSe), etc.); carbon-based photocatalysts (e.g., graphitic carbon nitride (g-C₃N₄)); and doped or modified photocatalysts (e.g., N-doped TiO₂, Ag-doped ZnO, Fe-doped WO₃, Co-doped g-C₃N₄, etc.).

The photocatalyst 204 may be activated by light from the external environment. For example, the light may include ambient sunlight, UV light (such as UV-A in the about 315-400 nm range), and/or, where visible light-responsive photocatalysts are used, the visible light of a suitable wavelength and intensity may be sufficient to activate the intended photocatalyst 204. The light may be pulsed or continuous in nature. In some implementations, ambient visible light alone may activate the photocatalyst 204 if appropriately tuned or doped. Upon activation, the photocatalyst 204 may generate reactive oxygen species (ROS) that oxidize water or hydroxide present in a pollutant (such as those mentioned above). This oxidation leads to mineralization of organic matter in the pollutant into carbon dioxide (CO₂) and water (H₂O ), and conversion of pollutant-derived atoms into stable inorganic ions (e.g., NO₃⁻, SO₄²⁻, halides) that are non-toxic under environmental conditions.

In one embodiment, the photocatalyst 204 may include or correspond to a “transitional” photocatalyst within the polymer binder 202. One or more types of “transitional” photocatalysts may be employed. The “transitional” photocatalyst may exhibit a hydrophobic-to-hydrophilic transition (or vice versa) when exposed to stimuli such as heat, UV light, visible light, or other physical agents (e.g., plasma treatment). Under the effect of these stimuli, such “transitional” photocatalyst may undergo a surface chemistry change (for example, generating hydroxyl groups on their surface) to become hydrophilic. In another embodiment, the polymer binder 202 may include one or more materials having inherent hydrophilic properties. These hydrophilic materials (illustrated as hydrophilic material 206 in FIG. 2) and the “transitional photocatalysts” together, or independent of each other in some embodiments, may (1) facilitate or increase the adsorption of pollutants on the first layer 102-1, and/or (2) assist in improving the efficiency of the oxidation reaction in degrading the pollutants. For example, suitable hydrophilic material 206 may include silica, polyvinylpyrrolidone (PVP), polyethylene glycol (PEG), poly(acrylic acid), or quaternized polysiloxanes. The hydrophilic material 206 may be present at about 0.1-10% by weight of a coating composition (or the polymer binder 202) in the first layer 102-1.

Examples of the polymer binder 202 include, but are not limited to, polyurethane, polyurea, siloxane, acrylic, and hybrids thereof such as aliphatic polyurethane hybrid and polyurethane-acrylate hybrid. Within the polymer binder 202, each photocatalyst 204 may be provided as particles (hereinafter “photocatalyst particles”) of a suitable size based on intended compositional parameters and application area. Examples of compositional parameters include dispersion uniformity, concentration, optical clarity, and texture of the coating. In one example, a photocatalyst particle may be configured as a nanoparticle; in another example, as a microparticle. The size of each photocatalyst particle may range from approximately 1 nanometer to approximately 0.1 micrometer (i.e., up to about 100 nm in diameter). In one embodiment, one or more photocatalyst particles (or photocatalyst 204) may be a composite of titanium dioxide (TiO₂) and graphene oxide (GO), referred to as photocatalytic composites C1 or C2. In such a composite, the titanium dioxide may be present in the anatase form, though rutile or brookite forms may also be contemplated. In some examples, one or more of the photocatalytic composites C1/C2 and/or the photocatalyst 204 may include anatase-form titanium dioxide in an amount ranging from about 0.5% to about 5% by weight of the photocatalytic coating composition (or of the total self-healing system 100). In some examples, the anatase-form titanium dioxide particles may have a size ranging from about 10-50 nm.

In one embodiment, the photocatalytic composite C1, C2 may be unbonded or bonded. In the unbonded photocatalytic composite (for example, composite C1 in FIG. 2), a titanium dioxide particle may not be chemically bonded to a graphene oxide particle. The presence of the graphene oxide near TiO₂ can (1) improve charge separation (electron transfer) from the TiO₂ particle to enhance photocatalytic activity and pollutant degradation efficiency, (2) augment pollutant adsorption, (3) elevate the mechanical strength of the first layer 102-1, and/or (4) extend light absorption for faster photocatalyst activation.

In a bonded photocatalytic composite (for example, composite C2 in FIG. 2), a titanium dioxide particle may be bonded to a graphene oxide particle via a covalent bond. This chemical bonding (TiO₂ covalently linked to GO) can further (1) improve efficient charge separation (electron transfer from TiO₂ to graphene) to slow down photocatalytic deactivation over time, (2) distribute mechanical stress between TiO₂ and GO particles to improve resistance to abrasion and crack propagation, (3) reduce or prevent TiO₂ particle agglomeration, maintaining a high surface area, (4) improve adhesion of the photocatalyst particles to the polymer binder 202 and/or the substrate 104, and/or (5) improve light sensitivity for photocatalyst activation. In some examples, the first layer 102-1 may include graphene oxide at about 0.25%-1.0% by weight of the photocatalytic coating composition (or of the total self-healing system 100). Other examples may include the first layer 102-1 having graphene oxide at about 5% to about 15% by weight of the self-healing coating composition in the second layer 102-2 (or of the entire system 100) to achieve these effects.

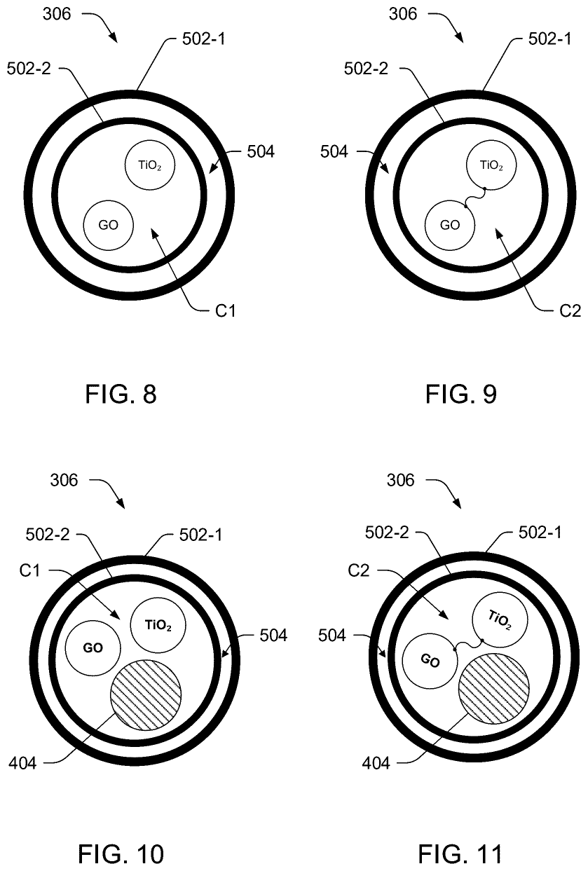

FIG. 3 is a schematic of an exemplary second layer 102-2 of the self-healing system 100 (from FIG. 1), according to an embodiment of the present application. In one embodiment, the second layer 102-2 includes one or more healing agents such as a healing agent 302 dispersed in a polymer matrix 304. In the present application, references to “healing agent” are intended to encompass a single healing agent or a plurality of healing agents. Unlike the polymer binder 202 (of the first layer 102-1) which provides a medium to hold photocatalyst particles and bond them to a surface (such as the second layer 102-2 or the substrate 104), the polymer matrix 304 of the second layer 102-2 provides a continuous phase in which the healing agent 302 may be embedded. In some examples, the polymer matrix 304 itself can be an integral part of the healing agent 302 (for instance, when the polymer matrix 304 may participate in self-healing reactions). In other examples, the polymer matrix 304 may include the same base polymer as binder 202 (or vice versa). In some instances, the polymer matrix 304 being same as the binder 202 may indicate some continuity between the layers 102. Examples of the polymer matrix 304 include, but are not limited to, a polyurethane-based matrix, an acrylate-based matrix, siloxane-based matrix, or a hybrid combination thereof such as polyurea hybrids, epoxy-polyurethane hybrids, styrene-acrylic copolymers, polyurethane-acrylic hybrids, epoxy-acrylic hybrids, hydroxyl-functional acrylic resins, siloxane-polyester resins, siloxane-polyurethane hybrids, epoxy-siloxane binders, silicone-alkyd resins, acrylic-siloxane copolymers, polyacrylate-siloxane hybrids, and acrylic-silicone emulsions. In some implementations, the polymer matrix 304 may be flexible or semi-rigid to allow some movement and crack closure at a damage site.

Examples of the healing agent 302 include, but are not limited to, isocyanate-terminated prepolymers, epoxy-amine dual-reactant systems, dynamic covalent bond networks (e.g., Diels-Alder reversible bonds), and supramolecular hydrogen bonding networks. In other examples, the healing agent 302 may include reactive oligomers and/or reversible bonding molecules. The healing agent 302 may operate to restore structural or functional properties of the polymer matrix 304 upon damage. The healing agent 302 may undergo healing chemistries (e.g., polymerization, reversible bond formation, crosslinking, etc.) within the bulk continuous phase of the polymer matrix 304. For example, when dynamic disulfide bonds in a polyurethane matrix are broken by a damage, the healing agent 302 can reform those bonds to close or repair the damage site without needing any external repair materials. In some cases, external materials may be added to assist repair, but the system 100 can be designed to be autonomous. In certain embodiments, the healing agent 302 may itself be encapsulated within an enclosure or shell that ruptures upon damage or under the effect of one or more physical agents such as humidity/moisture, heat, UV radiation, visible light, or mechanical force. Upon rupture of such an enclosure, the healing agent 302 may be released to heal a damage site on nearby surfaces, substrates, coating compositions, and/or functional layers 102. For example, a damage site may be present in the second layer 102-2, in the first layer 102-1, or at the interface between the first and second layers 102-1, 102-2, and the released healing agent 302 may flow into that site. In some embodiments, the second layer 102-2 may further include a hydrophilic material such as the hydrophilic material 206 in the first layer 102-1.

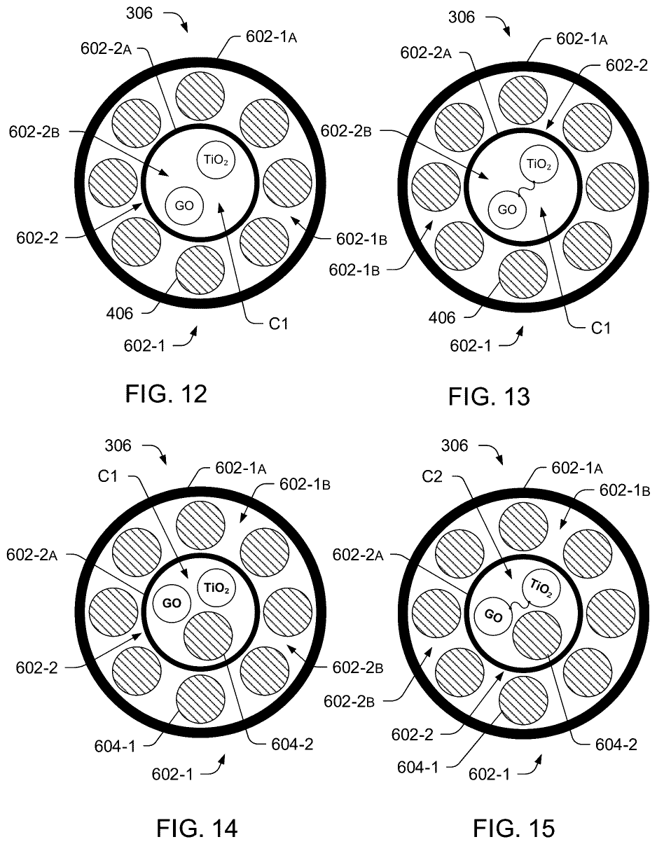

Further, in one embodiment, the second layer 102-2 includes one or more photocatalytic capsules dispersed in the polymer matrix 304. Each of the photocatalytic capsules, such as the capsule 306, may have any of a variety of configurations (shown in FIGS. 4-15). In a first embodiment, the capsule 306 may have a single shell configuration in which the capsule 306 may include a photocatalyst such as photocatalyst 204 encapsulated in a single shell 308. One example of the shell material is silica, though other suitable shell materials known in the art, including alumina and polymethyl methacrylate (PMMA), can be used. The encapsulated photocatalyst 204 can be any suitable photocatalytic material as mentioned above. For instance, in a first example (not shown), the photocatalytic capsule 306 may include titanium dioxide particles or any other suitable photocatalytic material, such as those mentioned above, inside the shell 308. In a second example, the capsule 306 may include a photocatalytic composite (like the aforementioned C1 or C2 composite of TiO₂ and graphene oxide) inside the shell 308. For instance, inside the shell 308, the photocatalytic composite C1 or C2 may be either bonded or unbonded (as described above for the first layer 102-1). As such, the photocatalytic capsule 306 may include the bonded composite C2 inside the shell 308, shown in FIG. 5. Alternatively, the capsule 306 may include the unbonded composite C1 encapsulated by the shell 308, shown in FIG. 4. However, some examples may include the capsule 306 having both the unbonded composite C1 and the bonded composite C2 inside the single shell 308. In a third example, the capsule 306 may include the unbonded composite C1 in addition to a healing agent 402 inside the shell 308, as shown in FIG. 6, so that rupture of the capsule 306 releases both types of materials. Alternatively, the capsule 306 may include the bonded composite C2 with the healing agent 402 inside the shell 308, as shown in FIG. 7, to release both types of materials upon capsule rupture. The healing agent 402 may represent or include a material same as those mentioned above for the healing agent 302.

In a second embodiment, the capsule 306 may have a dual-shell configuration including an outer shell 502-1 and an inner shell 502-2 (hereinafter collectively referred to as shells 502). The outer shell 502-1 may encapsulate the inner shell 502-2. The outer shell 502-1 may have dimensions (e.g., diameter, circumference, width, curvature, area, volume, etc.) relatively greater than those of the inner shell 502-2. Each of the shells 502 may be made of the same or different materials depending on the intended structural and/or functional properties. For example, relative to the inner shell 502-2, the outer shell 502-1 may be larger in size and made of materials that provide higher resistance to the external environment and/or the physical agents, such as those mentioned above, to (i) prevent premature shell rupture or leakage of the underlying photocatalyst (e.g., C1 or C2) before incurring damage, and (ii) avoid unintended capsule degradation over time to prolong the photocatalytic capacity and self-healing performance of the capsule 306. Examples of materials for the outer shell 502-1 include, but are not limited to, polyurethane, polyurea, and melamine-formaldehyde, silane-acrylic hybrids or any other suitable materials known in the art or developed later.

Similarly, the relative to the outer shell 502-1, the inner shell 502-2 may be smaller in size and made of materials that offer lower or intended resistance to the external environment and/or the physical agents, such as those mentioned above, to (i) enhance control over shell rupture for releasing the underlying photocatalyst upon incurring damage, and (ii) improve the shell stability under ambient conditions. Examples of materials for the inner shell 502-2 include, but are not limited to, silica, alumina, and polymethyl methacrylate (PMMA), or any other suitable materials known in the art or developed later.

In the dual-shell configuration, the inner shell 502-2 may encapsulate an intended photocatalyst 204 such as those mentioned above. For instance, in a first example (not shown), the photocatalytic capsule 306 may include particles of titanium dioxide or any other suitable photocatalytic material, such as those mentioned above, inside the inner shell 502-2. In a second example, as shown in FIG. 8, the capsule 306 may include the unbonded composite C1 inside the inner shell 502-2. Alternatively, as shown in FIG. 9, the capsule 306 may include the bonded composite C2 inside the inner shell 502-2. However, some examples (not shown) may include the capsule 306 having both the unbonded composite C1 and the bonded composite C2 inside the inner shell 502-2. In a third example, the capsule 306 may include the unbonded composite C1 in addition to a healing agent 404 inside the inner shell 502-2, as shown in FIG. 10. Alternatively, the capsule 306 may include the bonded composite C2 with the healing agent 404 inside the inner shell 502-2, as shown in FIG. 11. Other examples may include the capsule 306 having both the bonded and unbonded composite C1, C2 along with the healing agent 404 inside the inner shell 502-2. The healing agent 404 may represent or include a material same as those mentioned above for the healing agent 302.

In one embodiment, the shells 502 may have a predetermined gap 504 between them. The gap 504 may be empty or filled with any suitable material such as those mentioned above. For example, the gap 504 may be filled with a material same as the polymer binder 202 or the polymer matrix 304. Alternatively, the gap 504 may be filled with a mix of the polymer binder 202 and the polymer matrix 304 in any suitable proportion. The gap 504 may range from approximately 10 nm to approximately 300 nm depending on the size of the capsule 306 and relative sizes of the shells 502. However, in some examples, the gap 504 between the shells 502 may be less than 10 nm. For instance, the gap 504 may be zero, indicating the inner shell 502-2 being disposed in contact with the outer shell 502-1.

In a third embodiment, the capsule 306 may have a multi-layer shell configuration (not shown) including more than two shells. In the multi-layer composite shell configuration, the capsule 306 may include an outermost shell (similar to the outer shell 502-1) and one or more inner sub-shells (similar to the inner shell 502-2). The outermost shell may encapsulate the inner sub-shells. The outermost shell may be separated from an adjacent inner sub-shell; however, some examples may include the outermost shell being in contact with the adjacent inner sub-shell. Similarly, the inner sub-shells may be separated from each other, however, a set of two or more inner sub-shells pressed against each other may also be contemplated. Each pair of adjacent shells, in the multi-layer shell configuration, may include any suitable material, such as those mentioned above, between them. For instance, in a first example, the outermost shell and an adjacent inner sub-shell may include a photocatalytic material, such as those mentioned above, between them. In a second example, the outermost shell and an adjacent inner sub-shell may include between them the photocatalytic material in combination with at least one of a healing agent, same as the healing agent 402, and a material same as the polymer binder 202 and/or the polymer matrix 304.

In a third example, at least one pair of inner sub-shells may include the healing agent between them. In a fourth example, at least one pair of inner sub-shells may include the healing agent between them in combination with at least one of the photocatalytic material and a material same as the polymer binder 202 and/or the polymer matrix 304. In a fifth example, each pair of inner sub-shells may include a different combination of any of the aforementioned materials between them. In a sixth example, each alternate pair of inner sub-shells may have the same combination of one or more materials, such as those mentioned above, between them. In a seventh example, each alternate pair of inner sub-shells may have different combinations of one or more materials, such as those mentioned above, between them. In an eighth example, the innermost sub-shell may encapsulate at least one of the healing agent, the photocatalytic materials, the unbonded composite C1, and the bonded composite C2 in combination with a material same as the polymer binder 202 and/or the polymer matrix 304. In a nineth example, the outermost shell (or any of the inner sub-shells) may include at least one of the healing agent, the photocatalytic materials, the unbonded composite C1, and the bonded composite C2. In some embodiments, the multi-layer shell configuration may include the capsule 306 having at least one pair of adjacent shells having an empty hollow space (not shown) between them. The space between the adjacent shells may range from approximately 10 nm to approximately 300 nm depending on the size of the capsule 306. However, in some examples, the space between the shells may be less than 10 nm wide. In one embodiment, the outermost shell and at least one of the inner sub-shell may be made of the same or different materials. For example, the outermost shell may be made of any suitable material same as that mentioned above for the outer shell 502-1 and one or more of the inner sub-shells may be made of any suitable material same as that mentioned above for the inner shell 502-2.

In a fourth embodiment, the capsule 306 may have a nested capsule configuration. The nested capsule configuration may include a capsule, such as the capsule 306, encapsulating one or more capsules. In one implementation of the nested capsule configuration, the capsule 306 may be adapted to have a dual-capsule configuration (also, referred to as “capsule within a capsule” configuration). In the dual-capsule configuration, the capsule 306 may include an outer sub-capsule 602-1 and an inner sub-capsule 602-2 (hereinafter collectively referred to as sub-capsules 602). The outer sub-capsule 602-1 may encapsulate the inner sub-capsule 602-2. Unlike the multi-layer shell (or dual-shell) configuration which has a single capsule with a dedicated core, the nested (or dual-capsule) configuration includes multiple capsules, each with a dedicated core.

In the present application, a term “core” may refer to an internal portion (or a material in an internal portion) of a capsule that may be at least partially enclosed by one or more shell(s) or enclosure(s). The core may be distinguished from the shell by its location and/or composition. The core, in some examples, may provide a primary functional content or material of the capsule, such as capsule 306. As such, each of the sub-capsules 602 may include a shell and a core. For example, the outer sub-capsule 602-1 may include a first outer shell 602-1a and a first core 602-1b. Similarly, the inner sub-capsule 602-2 may include a second outer shell 602-2a and a second core 602-2b. Each of the first outer shell 602-1a and the second outer shell 602-2a (hereinafter collectively referred to as outer shells 602-a) may be made of the same or different materials such as those mentioned above. For example, the first outer shell 602-1a may be made of materials same as those for the outer shell 502-1, and the second outer shell 602-2a may be made of materials same as those for the inner shell 502-2. Similarly, each of the first core 602-1b and the second core 602-2b (hereinafter collectively referred to as cores 602-b) may include the same or different materials such as those mentioned above. For instance, in a first example (FIG. 12), the outer sub-capsule 602-1 may have the first core 602-1b including a healing agent 406 and the inner sub-capsule 602-2. In addition, the inner sub-capsule 602-2 may have the second core 602-2b including the unbonded composite C1.

In a second example (FIG. 13), the outer sub-capsule 602-1 may include the healing agent 406 and the inner sub-capsule 602-2 in the first core 602-1b, and the second core 602-2b may include the bonded composite C2. The healing agent 406 may represent or include a material same as those mentioned above for the healing agent 302. In a third example (FIG. 14), the outer sub-capsule 602-1 may include a first healing agent 604-1 and the inner sub-capsule 602-2 in the first core 602-1b, and the second core 602-2b may include the unbonded composite C1 in addition to a second healing agent 604-2. Each of the first healing agent 604-1 and the second healing agent 604-2 (hereinafter collectively referred to as healing agents 604) may be made of the same or different materials such as those mentioned above for the healing agent 302. In a fourth example (FIG. 15), the outer sub-capsule 602-1 may have the first core 602-1b including the first healing agent 604-1 and the inner sub-capsule 602-2. In addition, the inner sub-capsule 602-2 may have the second core 602-2b including the bonded composite C2 in addition to the second healing agent 604-2.

In a fifth example (not shown), the outer sub-capsule 602-1 may have the first core 602-1b including the first healing agent 604-1 in addition to at least one of the photocatalytic materials, the unbonded composite C1, and the bonded composite C2, while the inner sub-capsule 602-2 may have the second core 602-2b including the unbonded composite C1. In a sixth example (not shown), the outer sub-capsule 602-1 may have the first core 602-1b including the first healing agent 604-1 in addition to at least one of the photocatalytic material, the unbonded composite C1, and the bonded composite C2, while the inner sub-capsule 602-2 may have the second core 602-2b including the bonded composite C2. In a seventh example (not shown), the outer sub-capsule 602-1 may have the first core 602-1b including the first healing agent 604-1 in addition to at least one of the photocatalytic material, the unbonded composite C1, and the bonded composite C2, while the inner sub-capsule 602-2 may have the second core 602-2b including the unbonded composite C1 in addition to the second healing agent 604-2. In an eighth example (not shown), the outer sub-capsule 602-1 may have the first core 602-1b including the first healing agent 604-1 in addition to at least one of the photocatalytic material, the unbonded composite C1, and the bonded composite C2, while the inner sub-capsule 602-2 may have the second core 602-2b including the bonded composite C2 in addition to the second healing agent 604-2. This “capsule within a capsule” configuration or architecture may enable a sequential release (and/or a delayed release) mechanism for a core material (or the cores 602-b) under the influence of a physical agent such as those mentioned above.

In a fifth embodiment, the photocatalytic capsule 306 may include one or more photocatalyst types. For example, the capsule 306 may include both a titanium dioxide particle and a zinc oxide particle together inside the shell 308. In another example, the capsule 306 may include one particle of a TiO₂-based composite C1 or C2 and another separate ZnO particle within the same shell 308. In a third example, the capsule 306 may contain both a TiO₂-based composite C1/C2 and a ZnO-based photocatalytic composite. In a fourth example, the capsule 306 may include multiple titanium dioxide particles (e.g., several anatase TiO₂ nanoparticles) in one shell such as the shell 308. In a fifth example, the capsule 306 may include multiple particles of a titanium-dioxide/graphene photocatalytic composite C1 and/or C2. In a sixth example, a type of photocatalyst 204 inside the capsule 306 may be the same as that present in the first layer 102-1 (e.g., the top layer includes TiO₂, and the capsules also release TiO₂). In a seventh example, a type of photocatalyst 204 in the capsule 306 may be different from that present in the first layer 102-1 (e.g., providing a complementary photocatalytic material).

The photocatalytic capsule 306 can be formed in any suitable size based on intended composition, capsule parameters, and application. Examples of relevant capsule parameters include dispersion within the matrix, concentration of capsules, and resulting coating texture. In one example, the photocatalytic capsule 306 may be configured as a microcapsule. Such a microcapsule may have (1) a larger payload capacity (i.e., a larger size or multiple photocatalyst particles per capsule) which may be beneficial for filling larger cracks or gouges, (2) higher resistance to premature rupture, improving long-term stability, and/or (3) greater effectiveness against macro-damage such as visible scratches, chips, or coating delamination. In another example, the photocatalytic capsule 306 may be configured as a nanocapsule. Such a nanocapsule may (1) disperse evenly in the polymer matrix 304 to effectively address micro-crack initiation sites, (2) improve optical clarity (minimizing light scattering), which may be suitable for optical-grade, transparent, or decorative coatings or substrates, and/or (3) reduce the concentration of mechanical stress at any one point in the polymer matrix 304 (since smaller capsules create less local stress concentration). The size of each capsule, such as the capsule 306, may range from approximately 50 nanometers to approximately 1 micrometer in diameter.

In one embodiment, the second layer 102-2 can be prepared to include capsules of only one size category or a mix of different size categories. For example, the second layer 102-2 may include a self-healing coating composition comprising healing agent 302 and photocatalytic capsules, such as the capsule 306, dispersed in the polymer matrix 304. Each capsule, such as capsule 306, may have any suitable configuration such as those mentioned above. In one example, the self-healing composition includes photocatalytic capsules, such as capsule 306, solely as microcapsules (no nanocapsules), which may be suitable for coated articles comprising larger building and infrastructure components (for instance, wall panels or road surfaces). In another example, the self-healing composition includes photocatalytic capsules, such as capsule 306, solely as nanocapsules, which may be more suitable for coated articles like consumer or commercial products where a smooth or transparent finish is desired. In a further example, the self-healing composition includes a combination of microcapsules and nanocapsules, which can be advantageous for environmental or energy system modules (such as solar panel covers or wind turbine blades) to address damage across multiple length scales. In some examples, the photocatalytic capsules, such as capsule 306, may constitute about 5% to about 15% by weight of the self-healing coating composition (or of the overall system 100). Other examples of the self-healing coating composition may have the weight percentage of healing agent 302 lower than, higher than, or equal to that of the photocatalytic capsules, such as capsule 306, depending on the desired balance of healing and photocatalytic functions.

The photocatalytic capsules 306 may be configured to rupture under the influence of certain physical agents (or triggers) as mentioned above. For example, in one embodiment, the photocatalytic capsule 306 may rupture when exposed to passive ambient triggers such as increased humidity or moisture ingress at a damage site. The photocatalytic capsules, e.g., capsule 306, may receive the physical agent (or the trigger) emanating from the damage site (e.g., water seeping into a crack, or strain from the crack propagating). Upon rupture, the shell 308 of one or more of the capsules, such as capsule 306, may break and release the photocatalyst 204 and/or the healing agent 402 (or any of the healing agents 404, 406, or 604 depending on the capsule configuration) from within, directing these materials toward the damage site. The released photocatalyst 204 (for instance, a TiO₂/GO composite C1 or C2) replenishes the photocatalytic material at and near the damage site, thereby restoring the pollutant-removing capability of the affected area in the system 100 and/or the substrate 104. Simultaneously, the released healing agent 402 (if present from either the matrix 304 or capsule 306) works to repair the damage (e.g., fill or re-bond the crack). Advantageously, the released photocatalyst 204 and/or healing agent 402 tend to remain at or near the site of the damage and the adjacent surfaces/layers once exposed to atmospheric oxygen, which can cause these released materials to polymerize or otherwise bind at the damage site, anchoring them in place to effectuate the repair and regeneration in situ.

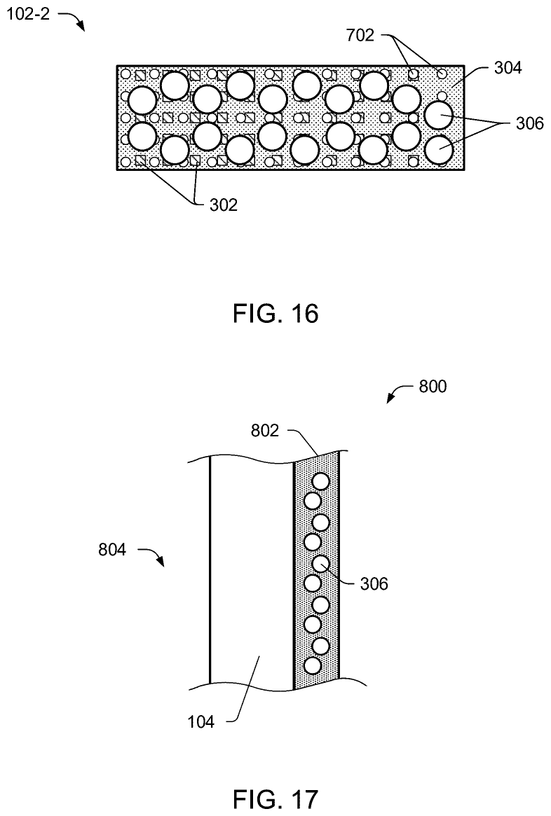

In one embodiment, the second layer 102-2 may further include one or more types of additives 702 (in addition to the primary functional ingredients) known in the art or later developed. For example, as illustrated in FIG. 16, the second layer 102-2 may include additives 702 such as acoustic damping fillers to damp vibrations, attenuate intended sound, and adjust the density of layer 102-2. Examples of acoustic damping fillers include, but are not limited to, cork powder, rubber crumb, polymer microspheres (hollow, solid, expandable, or viscoelastic), barium sulfate (BaSO₄), calcium carbonate (CaCO₃), mica, glass microspheres, and vermiculite, or any combinations thereof. In another example, the second layer 102-2 may include additives 702 such as modifiers to adjust or improve the flexibility, toughness, and/or crack resistance of layer 102-2. Examples of modifiers include, but are not limited to, elastomeric modifiers (e.g., acrylic elastomers, polyurethane elastomers, styrene-butadiene rubber (SBR), nitrile butadiene rubber (NBR), ethylene-propylene-diene monomer (EPDM) rubber, silicone elastomers, etc.); thickeners (e.g., cellulosic derivatives such as hydroxyethyl cellulose, polyurethane associative thickeners (HEURs), fumed silica or organoclays, etc.); and surface property modifiers (e.g., silicone additives, fluoropolymer additives, waxes such as PE, PTFE, carnauba, etc.).

Other types of additives 702 may include: (1) pigments to provide color and/or optical effects (e.g., pearlescence, color interference, fluorescence, phosphorescence, opalescence, holographic effects, color shift, light scattering, selective wavelength absorption/reflection, etc.); (2) structural fillers to improve mechanical strength and impact resistance; (3) flame-retardant fillers to improve fire resistance and electrical insulation; (4) thermally conductive fillers to dissipate heat; (5) density-modifying fillers to adjust weight distribution or to tailor affinity/resistance to environmental factors such as heat, radiation, moisture, and air; and (6) texture-control fillers to modify viscosity, flow characteristics, or surface feel of the coating (e.g., layer 102-2). Examples of structural fillers include, but are not limited to, glass fibers, carbon fibers, aramid fibers, and basalt fibers. Examples of flame-retardant fillers include aluminum hydroxide (ATH), magnesium hydroxide (MDH), and ammonium polyphosphate. Examples of thermally conductive fillers include boron nitride, aluminum oxide (Al₂O₃), and graphite. Examples of density-modifying fillers include hollow glass microspheres, expanded perlite, phenolic microspheres, barium sulfate, tungsten powder, and iron powder. Examples of texture-control fillers include fumed silica, talc, and wollastonite. Examples of pigments include inorganic pigments, organic pigments, functional pigments (e.g., photoluminescent pigments, UV-reflective or visible-light-reflective pigments, graphene nanoplatelets for conductivity, etc.), visual effect pigments (e.g., pearlescent or metallic flakes, color-changing pigments), and natural pigments (mineral-based, plant-based, or animal-based pigments).

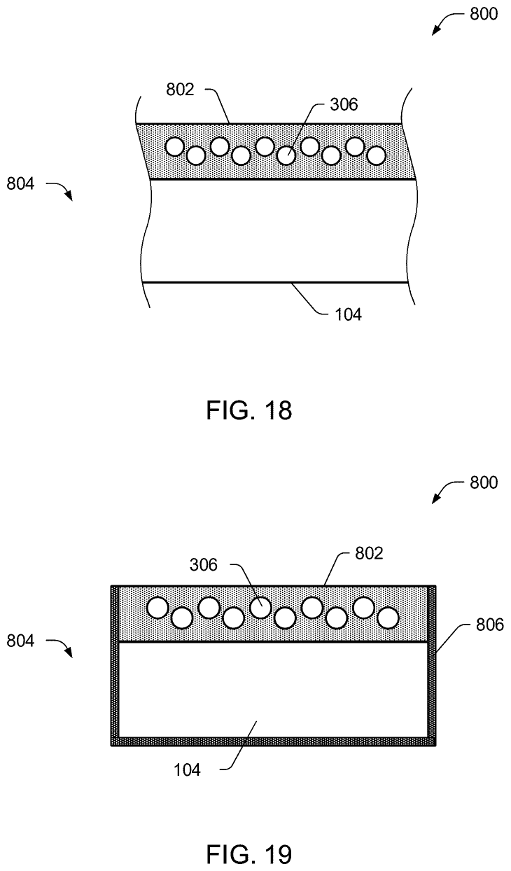

FIGS. 17-19 are schematics of an exemplary self-healing surface coating system 800 including a single functional layer 802 (monolithic configuration), according to various embodiments of the present application. In one embodiment, the self-healing system 800 has a monolithic configuration; for example, the system 100 consists of a single functional layer 802 applied or bonded onto the substrate 104 (e.g., in a coated article). The single functional layer 802 may be applied or bonded to surfaces that are vertical (FIG. 17), horizontal (FIG. 18), or angled relative to a longitudinal axis (or a central axis) of the system 800 and/or the substrate 104. In some examples, this single functional layer 802 may be applied via an intervening layer (not shown) similar to the third layer 102-3 described earlier. In one example, such an intervening layer can serve as a primer to assist adhesion of the single functional layer 802 to the substrate 104. The intervening layer may be distinct from the substrate 104 (or integral with the substrate 104 in some cases). In some examples, the intervening layer can include one or more sub-layers as needed for bonding.

The system 800, in some embodiments, may be applied or bonded to an article 804 having walls. For example, as shown in FIG. 19, the system 800 may be disposed in contact with one or more walls of the article 804. The walls may establish the physical boundaries of the article 804, provide structural support, and define a set volume. The article 104 may include the substrate 104 disposed within the defined volume of the article 804. In some examples, the walls may at least in-part enclose the substrate 104. As such, the system 800 (or layer 802) may be disposed over the substrate 104 and within external planes (e.g., vertical plane and/or horizontal plane) of the article 804. Each of the external planes may include an external surface (or an outermost surface) of the article 804. In one example, the external surface may be exposed to the external environment; however, some examples may include the external surface being located inside or adjacent to another article or surface. In some examples, the system 800 (or the layer 802) may be bonded or attached to the wall 806 while simultaneously being supported by the substrate 104. Such bonding may be chemical, mechanical, or a combination thereof, depending on a material composition of both the system 800 (or layer 802) and the wall 806. The walls may provide mechanical protection and/or support to the system 800, while the substrate 104 may provide a stable base for adhesion or support to the single layer 802.

In one embodiment, the single functional layer 802 may effectively combine the roles of the first layer 102-1 and second layer 102-2. For example, both the first and the second layers 102-1, 102-2 may be formed integral to each other to create the single functional layer 802. Thus, the single functional layer 802 may have a coating composition that includes aspects of both the photocatalytic coating composition (as described for layer 102-1) and the self-healing coating composition (as described for layer 102-2). The single functional layer 802 may include photocatalytic capsules, such as capsule 306, alone or in combination with the photocatalyst 204 and/or healing agent 302 all together in one layer. In some examples, the single functional layer 802 may further include the hydrophilic material 206 (and/or transitional photocatalysts as described above) and/or an additive 702 (such as those mentioned for the second layer 102-2).

The photocatalytic capsules, such as capsule 306, in the single layer 802 may include one or more of the same or different types of photocatalyst particles (or photocatalyst 204) as described earlier. The photocatalyst 204 in the single layer 802 may likewise include particles of one or more types of photocatalytic materials (and/or photocatalytic composites C1, C2) as described above. In essence, the single functional layer 802 may include various types of functional particles dispersed in a single polymer matrix, which may be analogous to the matrix 304 of the second layer 102-2.

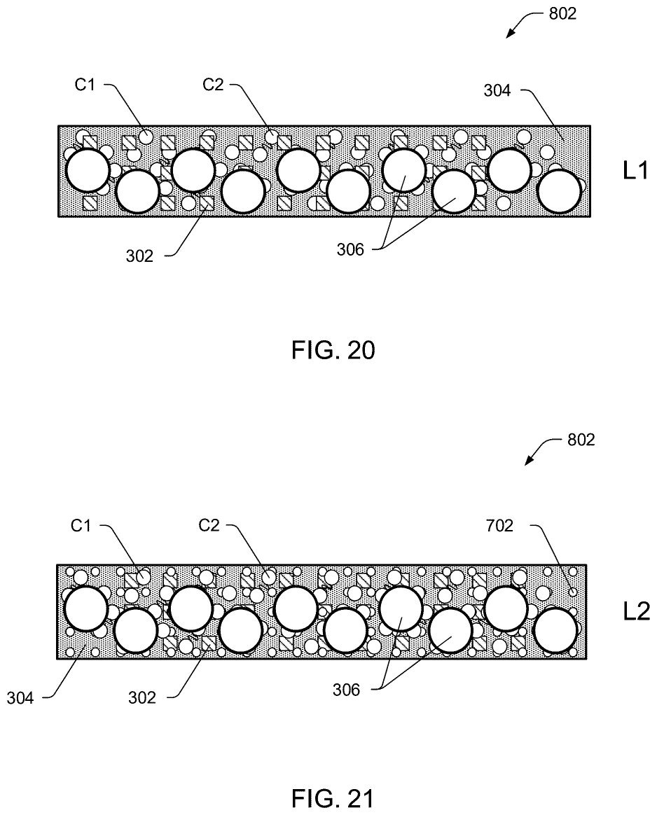

In a first illustrated example (denoted L1 in FIG. 20), the single functional layer 802 includes photocatalytic capsules, such as the capsule 306, along with the photocatalyst 204 and healing agent 302 dispersed in the polymer matrix 304. In a second illustrated example (denoted L2 in FIG. 21), the single functional layer 802 includes photocatalytic capsules such as the capsule 306, the photocatalyst 204, and the healing agent 302, in addition to the additives 702 (e.g., acoustic-damping fillers) in the polymer matrix 304. The capsule 306 may be present in any of the one or more configurations mentioned above. In some embodiments, the polymer matrix 304 of the single layer 802 may itself be made hydrophilic (or contain hydrophilic functional groups or materials such as those mentioned above) to improve pollutant adsorption on the layer 802 and to enhance the reaction efficiency for pollutant degradation when the photocatalyst 204 may be activated.

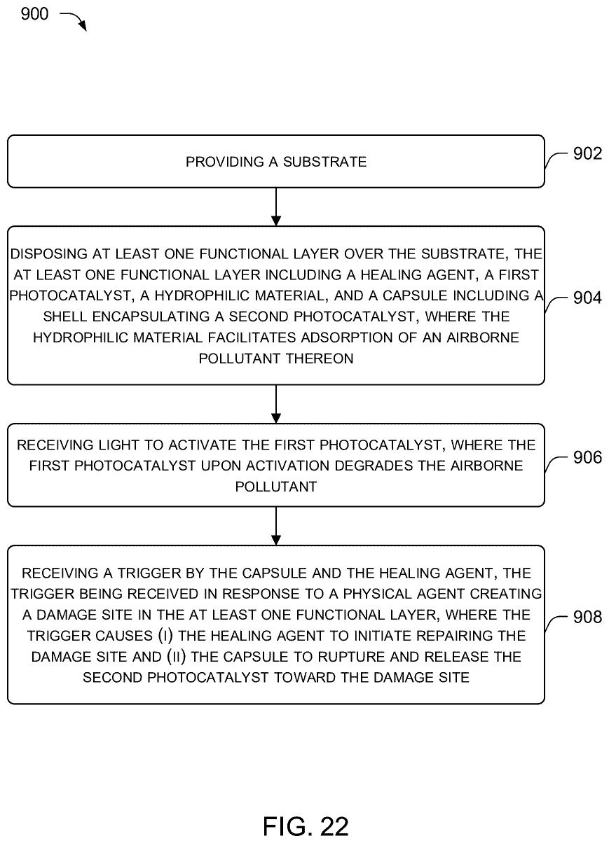

Having described the structure and function of the self-healing system 100, a method 900 (illustrated in FIG. 22) of implementing the system 100 to passively degrade pollutants while repairing a damage site in one or more functional layers 102 will now be described. One of ordinary skill in the art will recognize that the system 800 may be implemented in substitution for, or in combination, with the system 100 and in a manner analogous to that described with respect to method 900. In such embodiments, the system 800 may be configured to passively degrade pollutants while repairing the damage site in the functional layer 802 to operate in a manner consistent with, or functionally similar to, the operation described using the method 900. Although the method 900 is described in the context of treating airborne pollutants, it can be adapted to treat pollutants in other fluids such as liquids, gases, and vapors.

At step 902, a substrate 104 is provided. The substrate 104 may include any suitable material, surface, or article (or combination thereof) on which the self-healing system 100 can be implemented. In one example, the substrate's surface may be cleaned and/or profiled in preparation for coating of the system 100. Surface preparation can include mechanical methods (e.g., shot blasting, scarifying, grinding), abrasive blasting (sandblasting, steel shot, etc.), or acid etching, among others, to ensure good adhesion to the system 100. Examples of substrate materials include, but are not limited to, asphalt, concrete, stone, ceramic, metals, alloys, polymers, wood, and glass. The substrate 104 may be porous or non-porous. The substrate 104 may be flexible, semi-rigid, or rigid. In some examples, the substrate 104 can itself be or include a larger article or component as described earlier. Proper preparation of the substrate 104 may help (1) ensure strong adhesion of the coating layer(s) 102, 802 to the substrate surface, (2) reduce the risk of delamination under mechanical stress or environmental cycling, and/or (3) maintain long-term photocatalytic functionality by preventing premature coating failure.

At step 904, at least one functional layer is disposed over the substrate 104. Depending on the embodiment, the self-healing system 100 may be implemented in the multi-layer configuration (as in FIG. 1) or the monolithic (single-layer) configuration (as in FIGS. 17-19). In the multi-layer configuration, the system 100 includes an assembly of multiple functional layers 102 (for example, the first layer 102-1 and the second layer 102-2) disposed over the substrate 104. The second layer 102-2 may be applied, deposited, or bonded to the substrate 104 either directly or via an intervening layer such as the third layer 102-3. In some examples, the substrate 104 may at least in-part absorb or adsorb a portion of a layer (e.g., one or more of the functional layers 102, 802 and/or the intervening layer) in contact therewith. Similarly, the first layer 102-1 may be applied, deposited, or bonded to the second layer 102-2 either directly or via an intervening layer (which may be similar to the third layer 102-3). For instance, the first layer 102-1 may be exposed to the external environment (e.g., ambient air). The first layer 102-1 may cover the second layer 102-2, thereby preventing or minimizing exposure of the second layer 102-2 to the external environment. The first layer 102-1 functions as a purification layer that adsorbs and degrades a variety of pollutants (e.g., airborne pollutants) in the external environment. The first layer 102-1 may include a photocatalytic coating composition having one or multiple types of photocatalyst 204 (as described above) in a polymer binder 202. In some examples, the first layer 102-1 also includes the hydrophilic material 206 and/or a transitional photocatalyst, which may facilitate the adsorption of pollutants on the first layer 102-1.

The second layer 102-2 may be disposed in contact with the first layer 102-1 (e.g., layer 102-2 disposed beneath layer 102-1). The second layer 102-2 includes a self-healing coating composition comprising the healing agent 302 (as described above) in the polymer matrix 304. The healing agent 302 may be configured to heal or repair a damage site at the interface of the first layer 102-1 and second layer 102-2 (or within the second layer 102-2 itself). In one embodiment, the second layer 102-2 (and its self-healing coating composition) may further include one or more of the same or different types of photocatalytic capsules, such as the capsule 306, in the polymer matrix 304. Each photocatalytic capsule, such as capsule 306, has the shell 308 encapsulating a photocatalyst such as the photocatalyst 204. The encapsulated photocatalyst 204 may be any suitable material as noted above (e.g., TiO₂ particles, or composite particles C1/C2). For example, the photocatalytic capsule 306 may encapsulate a titanium dioxide particle in the shell 308; in another example, the capsule 306 may encapsulate the photocatalytic composite C1 or C2. In some examples, the photocatalytic capsule 306 (in the second layer 102-2) may also encapsulate the healing agent 402 (or any of the healing agents 404, 406, or 604 depending on the capsule configuration) along with the photocatalyst 204, as described previously.

In some embodiments, the capsule 306 may comprise a multi-layer composite shell, such that the outermost shell (similar to the outer shell 502-1) may encapsulate the inner sub-shell (similar to inner shell 502-2) as well as the photocatalytic material (e.g., TiO₂/GO), and the inner sub-shell may encapsulate a healing agent such as the healing agent 404, 604-2. Upon exposure to a physical agent or trigger (e.g., moisture ingress), the outermost sub-shell may facilitate pollutant degradation at the surface, while the inner sub-shell may deliver healing chemistry to damaged portions of the substrate 104 and/or the system 100.

In certain embodiments, the second layer 102-2 (e.g., middle layer) may comprise microcapsules with a nested or dual-capsule configuration, where the outer sub-capsule 602-1 may include the healing agent 604-1 (such as a polymeric resin, epoxy, or polyurethane derivative), and the inner sub-capsule 602-2 (encapsulated within the outer sub-capsule 602-1) may include the photocatalyst 204 (such as titanium dioxide, zinc oxide, photocatalytic composites C1/C2, or a metal-organic framework). This dual-compartment structure may enable sequential release of the encapsulated healing agent 604-1 and the photocatalytic material in response to surface damage or the trigger therefrom. For example, upon mechanical disruption or environmental wear, the outer sub-capsule 602-1 may rupture or degrade, releasing the encapsulated healing agent 604-1 to seal or repair the damaged area. As the repair proceeds, the inner sub-capsule 602-2 may subsequently rupture or become exposed, releasing the photocatalyst 204 to restore the surface's pollutant-degrading function. This “capsule-within-capsule” architecture provides an enhanced regenerative mechanism compared to single-shell or co-encapsulated systems. The encapsulated capsules, e.g., sub-capsules 602, may be manufactured using known techniques such as interfacial polymerization, double-emulsion, or core-shell precipitation techniques, allowing controlled layering, delayed activation, or trigger-based release under specific environmental conditions (or physical agents) such as humidity or temperature shifts.

In certain embodiments, the layer 102-2 (e.g., intermediate or middle layer) may comprise the multi-layer shell capsule structures, where each capsule 306 (e.g., in the form of microcapsule) may include an outer shell 502-1 including or encapsulating a healing agent such as the healing agent 404. Such a capsule 306 may further include the inner shell 502-2 (encapsulated within the outer shell 502-1) including or encapsulating a photocatalyst such as the photocatalyst 204 and/or the composite C1, C2. This shell-within-shell architecture may enable a sequential release and/or a delayed release mechanism, e.g., upon mechanical abrasion or surface damage, the outer shell 502-1 may rupture or degrade, releasing the encapsulated healing agent (e.g., polyurethane, polyurea, or epoxy-based resin) to repair surface-level cracks or fissures. As surface healing occurs and further environmental exposure (e.g., humidity, UV, or wear) continues, the inner shell 502-2 may become exposed and rupture, releasing the encapsulated photocatalyst 204 (e.g., titanium dioxide, zinc oxide, or graphene oxide), and/or composites C1/C2 to restore or regenerate the pollutant-degrading functionality of a surface such as that of the substrate 104. The inner shell 502-2 may be made of or comprise silica, alumina, PMMA, or inorganic-organic hybrid shell materials, while the outer shell 502-1 may use or contain moisture-reactive or UV-degradable shells. This multi-compartmental encapsulation design may provide a redundant and extended regenerative lifespan, differentiating it from conventional single-shell microcapsules or static photocatalytic films. Manufacture of such multi-layer shell capsules, such as capsule 306, may involve any suitable techniques known in the art including double-emulsion techniques, coacervation, interfacial polymerization, or templated shell construction.

On the other hand, in the monolithic configuration, the self-healing system 100 may be configured as the system 800 including the single functional layer 802 disposed over the substrate 104 (either directly or via a primer layer like the third layer 102-3). The single functional layer 802 may include the healing agent 302, a first photocatalyst, the hydrophilic material 206 (and/or a transitional photocatalyst), and at least one photocatalytic capsule such as capsule 306 having the shell 308 encapsulating a second photocatalyst. Each of the first photocatalyst and the second photocatalyst may include a photocatalytic material such as those mentioned above for the photocatalyst 204. In one example, the first photocatalyst may correspond to or include a photocatalyst such as the photocatalyst 204 and the second photocatalyst may correspond to or include the composite C1 and/or C2. As such, the first photocatalyst 204 may be different from the second photocatalyst C1/C2. However, in some examples, the second photocatalyst may include any other type of photocatalytic material such as those mentioned above. As such, in some implementations, the second photocatalyst may include a photocatalytic material same as that present in the first photocatalyst. Further, the hydrophilic material 206 (and/or transitional photocatalyst) provided in the single layer 802 may facilitate adsorption of airborne pollutants onto the layer 802.

At step 906, the first photocatalyst is activated. In the monolithic configuration, the single functional layer 802 may receive or be exposed to light (e.g., ambient UV/visible light) to activate the first photocatalyst 204 contained in the matrix 304 (or a coating composition) of that layer 802. Similarly, in the multi-layer configuration, the photocatalyst 204 in the first layer 102-1 may be activated by exposing that layer 102-1 to ambient light (UV and/or visible, as needed). Once activated, the first photocatalyst, e.g., photocatalyst 204, in the first layer 102-1 (or in the single layer 802) degrades the airborne pollutant upon contact.

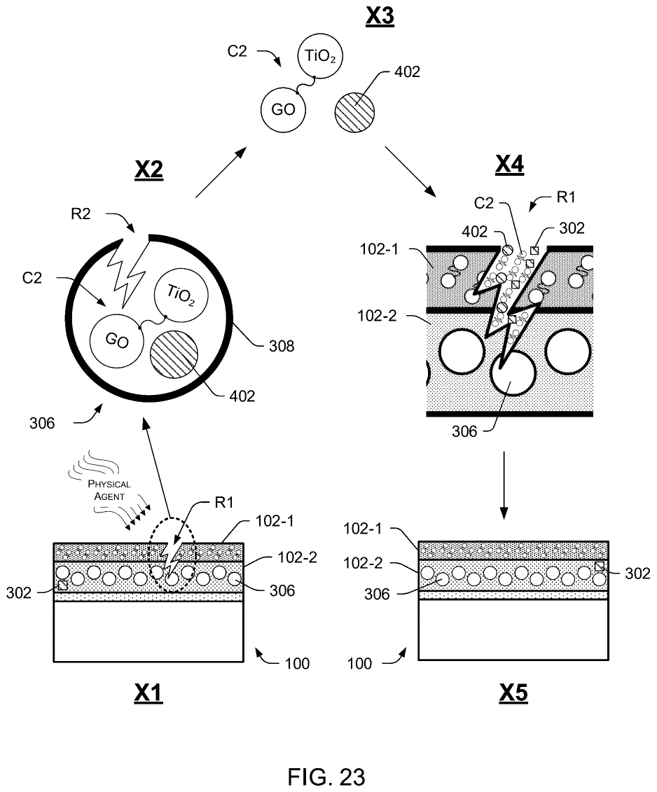

At step 908, a trigger is received by the capsule 306 and the healing agent 302 (e.g., a damaging event occurs that initiates a self-healing cycle). In one embodiment, the single functional layer 802 may be subjected to a physical agent (e.g., in the form of an impact or stress) that creates a damage site R1 in it. Examples of the physical agent include humidity/moisture ingress, heat, UV radiation, visible light exposure, and/or mechanical force (stress or impact). Similarly, in a multi-layer coating configuration, as illustrated in FIG. 23, at event X1, such a physical agent can create the damage site R1 in the first layer 102-1, in the second layer 102-2, and/or at an interface (e.g., boundary, edge, border, periphery, junction, transition region, etc.) between these first layer 102-1 and the second layer 102-2. When this damage site R1 extends to the interface (or exists within the single layer 802 in the monolithic configuration), the physical agent via the damage site R1 may effectively deliver or provide a medium to trigger both the capsule 306 and the nearby healing agent 302 dispersed in the first layer 102-1 and/or the second layer 102-2, 802. In one embodiment, the primary trigger may be moisture ingress into a crack (e.g., damage site R1); however, other triggers such as the occurrence of a surface scratch (introducing local strain) or other physical stimuli or agents such as those mentioned above can be contemplated. In the illustrated example, the capsule 306 encapsulates the healing agent 402; however, some examples may additionally or alternatively include the healing agent 302 dispersed in the second layer 102-1, 802 and/or the first layer 102-1.

Upon receiving the trigger (for instance, moisture exposure at the crack), the healing agent 302 may be activated to initiate healing/repair of the damage site R1. At the same time, the trigger may be conveyed to the capsules such as the capsule 306. In the illustrated example, the capsule 306 may encapsulate the second photocatalyst (e.g., composite C2) and the healing agent 402. At event X2, the capsule 306 may rupture (event site R2) due to the trigger and, at event X3, release the healing agent 402 and the second photocatalyst (e.g., composite C2) from within, directing both the released healing agent 402 and the second photocatalyst toward the damage site R1 (event X4). The released second photocatalyst (e.g., composite C2) replenishes and/or restores the photocatalytic capacity at the location R1 of damage in the first layer 102-1 and the second layer 102-2 (or in the single functional layer 802, for the monolithic configuration). Additionally, the released healing agent 402 from the capsules, such as capsule 306, also assist in repairing and restoring a structural integrity of the damage site R1. In other words, at event X5, even if some photocatalytic material may be lost or rendered ineffective at the damage site R1 (e.g., crack), the new photocatalyst (e.g., composite C2) released from the capsule, e.g., capsule 306, ensures the air-purifying function is renewed once the area (e.g., damage site R1) may be healed by the healing agents 302, 402.

While the foregoing detailed description enables one of ordinary skill to make and use the best mode of the invention as presently contemplated, it will be understood that variations, combinations, and equivalents of the specific embodiments, methods, and examples described herein may exist. The invention, therefore, should not be limited by the particular embodiments and examples disclosed, but by the scope of the claims.

I/We claim:

1. A self-healing air purification system, comprising:
a substrate;
a first functional layer disposed over the substrate, the first functional layer including a first photocatalyst and a hydrophilic material, wherein the first photocatalyst is configured to degrade a pollutant and the hydrophilic material is configured to facilitate adsorption of the pollutant thereon;
a second functional layer disposed in contact with the first functional layer, wherein the second functional layer includes a first healing agent configured to heal a damage site at an interface of the first functional layer and the second functional layer; and
a first capsule dispersed in the second functional layer, the first capsule including a first shell encapsulating a second photocatalyst, wherein the first shell is configured to rupture upon exposure to a physical agent to release the second photocatalyst toward the damage site.

2. The system as claimed in claim 1, wherein the first shell ruptures in response to moisture ingress or local strain at the damage site, and wherein the physical agent includes at least one of moisture, ultraviolet radiation, visible light, heat, and mechanical force, and wherein the first shell further encapsulates a second healing agent.

3. The system as claimed in claim 1, wherein the first photocatalyst and the second photocatalyst include the same photocatalytic material.

4. The system as claimed in claim 1, wherein the second photocatalyst includes a composite of titanium dioxide and graphene oxide.

5. The system as claimed in claim 1, wherein the first photocatalyst and the second photocatalyst are selected from a group comprising titanium dioxide, zinc oxide, tungsten trioxide, tin dioxide, ferric oxide, bismuth vanadate, strontium titanate, potassium tantalate, sodium niobate, calcium ferrite, cadmium sulfide, zinc sulfide, molybdenum disulfide, copper indium disulfide, cadmium selenide, carbon-based photocatalysts, and doped photocatalysts.

6. The system as claimed in claim 1, wherein the first healing agent includes at least one of isocyanate-terminated prepolymers, epoxy-amine, dynamic covalent networks, and hydrogen bonding networks.

7. The system as claimed in claim 1, wherein the second functional layer further includes an additive selected from a group comprising acoustic-damping fillers, pigments, structural fillers, flame-retardant fillers, thermal conductive fillers, density-modifying fillers, elastomeric modifiers, and texture-control fillers.

8. The system as claimed in claim 1, wherein the first capsule further includes a second shell encapsulating the first shell, the second shell being configured to rupture upon exposure to the physical agent, wherein the second shell, upon being ruptured, exposes the first shell to the physical agent.

9. The system as claimed in claim 1, further comprising a second capsule dispersed in the second functional layer, the second capsule encapsulating the first capsule and a third healing agent, wherein the second capsule is configured to rupture upon exposure to the physical agent to release the first capsule and the third healing agent toward the damage site.

10. The system as claimed in claim 1, wherein the first photocatalyst is activated upon exposure to ambient light, wherein the activated first photocatalyst degrades the pollutant upon contact therewith.

11. A self-healing air purification system, comprising:
a substrate;
at least one functional layer disposed over the substrate, the at least one functional layer including a first healing agent, a first photocatalyst, and a hydrophilic material, wherein the first healing agent is configured to heal a damage site proximate to the at least one functional layer, the first photocatalyst is configured to degrade a pollutant, and the hydrophilic material is configured to facilitate adsorption of the pollutant thereon; and
a first capsule dispersed in the at least one functional layer, the first capsule including a first shell encapsulating a second photocatalyst, wherein the first shell is configured to rupture upon exposure to a physical agent to release the second photocatalyst toward the damage site.

12. The system as claimed in claim 11, wherein the first shell ruptures in response to moisture ingress or local strain at the damage site, and wherein the physical agent includes at least one of moisture, ultraviolet radiation, visible light, heat, and mechanical force, and wherein the first shell further encapsulates a second healing agent.

13. The system as claimed in claim 11, wherein the first photocatalyst and the second photocatalyst include the same photocatalytic material.

14. The system as claimed in claim 11, wherein the second photocatalyst includes a composite of titanium dioxide and graphene oxide.

15. The system as claimed in claim 11, wherein the first photocatalyst and the second photocatalyst are selected from a group comprising titanium dioxide, zinc oxide, tungsten trioxide, tin dioxide, ferric oxide, bismuth vanadate, strontium titanate, potassium tantalate, sodium niobate, calcium ferrite, cadmium sulfide, zinc sulfide, molybdenum disulfide, copper indium disulfide, cadmium selenide, carbon-based photocatalysts, and doped photocatalysts.

16. The system as claimed in claim 11, wherein the first healing agent includes at least one of isocyanate-terminated prepolymers, epoxy-amine, dynamic covalent networks, and hydrogen bonding networks.

17. The system as claimed in claim 11, wherein the at least one functional layer further includes an additive selected from a group comprising acoustic-damping fillers, pigments, structural fillers, flame-retardant fillers, thermal conductive fillers, density-modifying fillers, elastomeric modifiers, and texture-control fillers.

18. The system as claimed in claim 11, wherein the first capsule further includes a second shell encapsulating the first shell, the second shell being configured to rupture upon exposure to the physical agent, wherein the second shell, upon being ruptured, exposes the first shell to the physical agent.

19. The system as claimed in claim 11, further comprising a second capsule dispersed in the at least one functional layer, the second capsule encapsulating the first capsule and a third healing agent, wherein the second capsule is configured to rupture upon exposure to the physical agent to release the first capsule and the third healing agent toward the damage site.

20. The system as claimed in claim 11, wherein the first photocatalyst is activated upon exposure to ambient light, wherein the activated first photocatalyst degrades the pollutant upon contact therewith.

21. A method of implementing a self-healing air purification system, the method comprising:
providing a substrate;
disposing at least one functional layer over the substrate, the at least one functional layer including a first healing agent, a first photocatalyst, a hydrophilic material, and a first capsule encapsulating a second photocatalyst, wherein the first healing agent heals a damage site proximate to the at least one functional layer and the hydrophilic material facilitates adsorption of the pollutant thereon;
receiving light to activate the first photocatalyst, wherein the first photocatalyst, upon activation, degrades the pollutant; and
receiving a trigger by the first capsule and the first healing agent, the trigger being received in response to a physical agent creating the damage site in the at least one functional layer, wherein the trigger causes (i) the first healing agent to initiate repairing the damage site and (ii) the first capsule to rupture and release the second photocatalyst toward the damage site.

22. The method as claimed in claim 21, wherein the trigger includes moisture ingress or local strain at the damage site, and wherein the physical agent includes at least one of moisture, ultraviolet radiation, visible light, heat, and mechanical force.

23. The method as claimed in claim 21, wherein the step of receiving a trigger further comprises receiving the trigger by a first shell in the first capsule, the first shell encapsulating a second healing agent and the second photocatalyst, wherein the first shell ruptures upon exposure to the physical agent to release the second healing agent and the second photocatalyst toward the damage site.

24. The method as claimed in claim 23, wherein the trigger is received by a second shell encapsulating the first shell, wherein the second shell ruptures upon exposure to the physical agent to expose the first shell to the physical agent.

25. The method as claimed in claim 21, wherein the step of receiving a trigger further comprises receiving the trigger by a second capsule dispersed in the at least one functional layer, the second capsule encapsulating the first capsule and a third healing agent, wherein the second capsule ruptures upon exposure to the physical agent to release the first capsule and the third healing agent toward the damage site.
